(19) United States
(12) Patent Application Publication
(10) Pub. No.: US 2010/0095195 A1
(43) Pub. Date: Apr. 15, 2010

(54) Defining spreadsheet functions

(75) Inventors: Michael Jeremy Coblenz, Sunnyvale, CA (US); Maxence Lloyd Crossley, Pittsburgh, PA (US); Yik Shing Yip, Pittsburgh, PA (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Inc.

(21) Appl. No.: 12/288,116

(22) Filed: Oct. 15, 2008

(51) Int. Cl. G06F 17/00

(52) U.S. Cl. 715/212; 707/E17.005

(57) ABSTRACT

Defining spreadsheet function behavior is disclosed. In some embodiments, in response to receiving a selection of a parameterized spreadsheet function behavior to be associated with a spreadsheet function, the parameterized spreadsheet function behavior is associated with the spreadsheet function based at least in part on the selection. In some embodiments, the parameterized spreadsheet function behavior is associated with a behavior of the function with respect to one or more arguments of the function.

### BACKGROUND OF THE INVENTION

Spreadsheet applications provide various functions that can be employed to perform computations and other operations. Typically, during development for each spreadsheet function the behavior of that function must be specified by a developer explicitly in a definition of the function, including the behavior of the function with respect to arguments of the function.

### BRIEF DESCRIPTION OF THE DRAWINGS

Various embodiments of the invention are disclosed in the following detailed description and the accompanying drawings.

FIG. 1 shows a functional block diagram that illustrates an embodiment of a system that generates code associated with a spreadsheet application.

FIG. 2A illustrates an embodiment of a process for adding and/or updating a function record in a database.

FIG. 2B illustrates an embodiment of a user interface for selecting and/or specifying one or more properties associated with function arguments.

FIG. 3 illustrates an embodiment of a process for generating source code for function argument behavior of a function that is specified in an associated record in a database.

FIG. 4 illustrates an embodiment of a runtime process for retrieving code associated with function argument behavior.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

As used herein, the term “cell” refers to a cell associated with at least standard spreadsheet functionality. The term “at least standard spreadsheet functionality” in the context of a cell includes the ability to define the content of one cell in such a way that the content of the one cell is determined based at least in part on the content of one or more other cells, and the content of the one cell is updated automatically without further human action if the content of one or more of the one or more other cells is changed. A spreadsheet cell may include a formula that comprises one or more predefined and/or custom functions. The definition of a function may specify one or more required and/or optional arguments. Although many of the examples provided herein are with respect to a spreadsheet application, the techniques described herein may be similarly employed with respect to any application, spreadsheet or otherwise.

As disclosed herein, in some embodiments, the behavior of a function with respect to its arguments is at least in part parameterized. That is, the behavior associated with the arguments of a function is at least in part abstracted or factored out from the rest of the function definition. Such an abstraction of function argument behavior facilitates reuse of the associated code across a plurality of functions with respect to which the behavior is applicable. Code reuse has many advantages including providing consistency across various functions whose arguments exhibit similar behavior, reduced errors or bugs, easier implementation of functions during development, etc. As further described below, in some embodiments, at least some standard properties associated with function arguments are parameterized and specified separately from the rest of the function definition. As used herein, the term “parameterize” refers to abstracting a behavior of a function (e.g., a behavior of a function with respect to an argument of the function) from the rest of the definition of the function.

Although many of the examples described herein are with respect to parameterizing and separately specifying the behavior of a function with respect to its arguments, in other embodiments, the disclosed techniques may be employed with respect to any other behavior associated with a function.

A function may have one or more arguments. The function arguments of functions may be associated with various properties. For example, some function arguments may be required while others may be optional. Some function arguments may be restricted to one or more prescribed data types, and/or one or more prescribed data types may be disallowed for some function arguments. Some function arguments may be restricted to values within prescribed ranges. Some functions arguments may be restricted to one or more prescribed (mode) values. Function arguments comprising Boolean values may be coerced or converted into numerical values (e.g., 1 for TRUE and 0 for FALSE) by some functions but may be disallowed by other functions. Function arguments comprising header row and/or column references may be ignored or disallowed by some functions but accepted by other functions. Vectors (e.g., a range, list, or array) may be accepted for some function arguments while some function arguments may be restricted to scalar values. Function arguments comprising referenced cells whose values have certain data types may be ignored or skipped by some functions while directly entered arguments of those same data types may be individually considered by the functions. In some embodiments, errors may be specified for function argument values that are not accepted and/or are disallowed. Although examples of some properties that may be associated with function arguments have been provided, various function arguments may be associated with any one or more applicable properties.

To illustrate an example of some properties associated with function arguments, consider, for instance, the plus (+) operator and the SUM function in typical spreadsheet applications. Numerical arguments associated with a plus operator and numerical arguments associated with a SUM function are added together. In some cases, the plus operator permits operands that are numerical values expressed as strings. In such cases, the numerical values expressed as strings are converted into corresponding numerical values. For example, the computation 1+“1”+2 yields a result of 4 since the string “1” is converted into a numerical value of 1. However, a computation such as 1+2+“q” results in an error since the string “q” does not comprise a numerical value expressed as a string. Similarly, the SUM function permits numerical values expressed as strings in the cases in which the arguments are directly specified. For example, the computation SUM(1,“1”,2) yields a result of 4 since the string “1” is converted into a numerical value of 1, and a computation such as SUM(1,2,“q”) results in an error since the string “q” does not comprise a numerical value expressed as a string. However, in the cases in which one or more arguments of the SUM function comprise cell references, the cell references that are associated with non-numerical values are ignored in the computation. For example, assume that cells B1, B2, B3, and B4 have values 1, “1”, 2, and “q”, respectively. In this case, the computation SUM(B1:B3) yields a result of 3 since the string “1” in cell B2 is ignored, and the computation SUM(B1:B4) also yields a result of 3 since the string “1” in cell B2 and the string “q” in cell B4 are ignored. Thus, as is apparent from the given examples, the properties of various function arguments may depend on the context in which they are used.

In some embodiments, standard or common code associated with the manner in which functions behave with respect to their associated function arguments (e.g., code associated with accessing or checking argument values, converting Booleans to numerical values, ignoring empty cells in a range or those that include non-numerical values, etc.) that is not specific to actual function behavior is at least in part abstracted from the function definitions of at least a subset of spreadsheet functions so that, for example, the code can be reused. In some such cases, various function argument properties are parameterized, and values of such function argument properties for one or more functions are separately specified and collectively stored in a database.

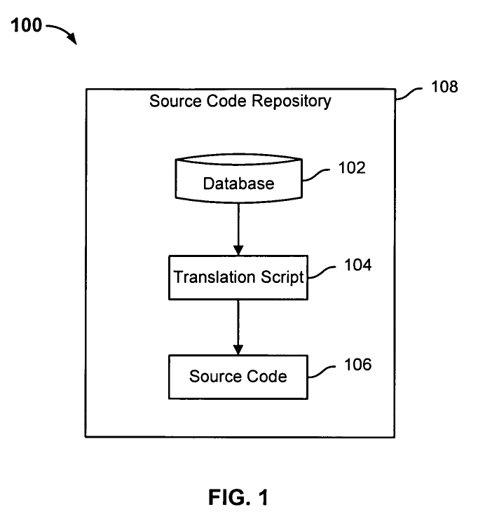

FIG. 1 shows a functional block diagram that illustrates an embodiment of a system 100 that generates code associated with a spreadsheet application. In the given example, database 102 includes a record for each of at least a subset of spreadsheet functions. Each record includes selections and/or specifications of one or more function behaviors, for example with respect to arguments and/or argument properties. The data values in the records of database 102 are translated by translation script 104 to generate source code 106. In the given example, database 102, translation script 104, and source code 106 are stored in source code repository 108. In some cases, source code underlying parameterized function behavior is stored in source code repository 108 (or in other embodiments some other repository or database) and retrieved, as applicable, by translation script 104 when mapping values in a function record to existing source code that implements the selected and/or specified behavior to generate source code associated with the function. In some embodiments, any changes to database 102 (e.g., by a developer) result in translation script 104 to be executed to generate updated source code 106 for the function behavior. Source code repository 108 may also include other source code, such as other source code of the associated spreadsheet application and/or other applications. For example, source code repository 108 may include source code associated with function definitions that define the behavior of functions. At compilation time, one or more source code files stored in source code repository 108 are processed by a compiler, linker, and/or various build scripts to generate one or more associated binary files. In some embodiments, if a parameterized function behavior (e.g., the associated code) is changed in one place, e.g., a primary or source record for the behavior, the source code for each function with respect to which the parameterized behavior has been invoked is automatically updated.

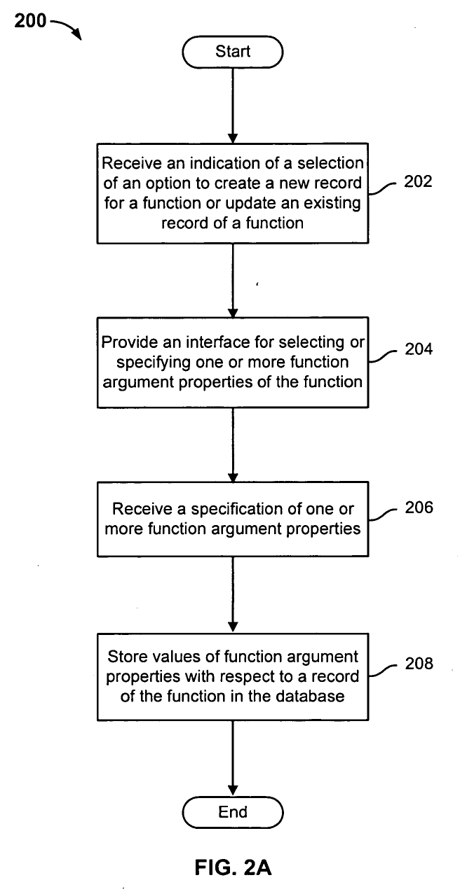

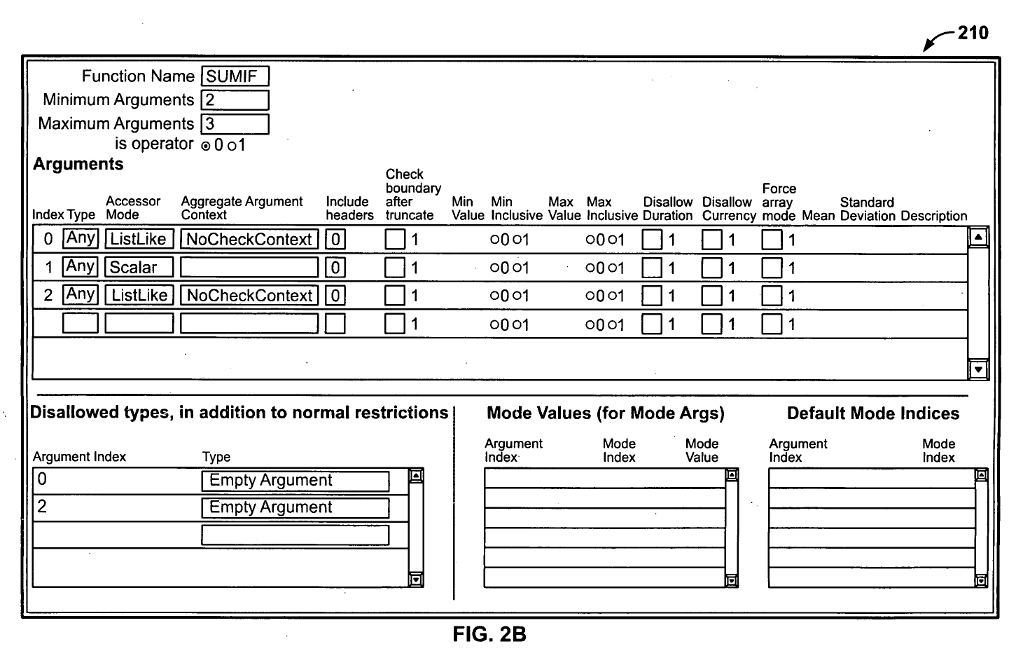

FIG. 2A illustrates an embodiment of a process for adding and/or updating a function record in a database. For example, process 200 may be employed to create a new record or update a record in database 102 of FIG. 1. Process 200 starts at 202 at which an indication of a selection of an option to create a new record for a function and/or update an existing record of a function is received. At 204, a user interface for selecting and/or specifying one or more function argument properties for the function is provided. At 206, a selection and/or specification of one or more function argument properties is received, for example, via the interface provided at 204. At 208, the values of the function argument properties received at 206 are stored with the record of the function in the database, and process 200 subsequently ends.

FIG. 2B illustrates an embodiment of a user interface 210 for selecting and/or specifying one or more properties associated with function arguments. For example, in some embodiments, user interface 210 is provided at 204 of process 200. As depicted in the given example, user interface 210 includes input fields, drop down menus, check boxes, and/or radio buttons to specify various properties including function name, minimum number of function arguments, maximum number of function arguments, whether the function comprises an operator, various properties associated with one or more function arguments (e.g., argument type, accessor mode, context, whether to include headers, whether to check boundaries, minimum and maximum values, whether to disallow certain data types, a description of the argument, etc.), disallowed types for one or more function arguments, mode values for one or more function arguments, etc. User interface 210 of FIG. 2B comprises one example of a user interface that can be used to configure and/or specify various function argument properties. In other embodiments, any appropriate user interface that allows any one or more function argument properties to be specified, configured, and/or selected may be employed.

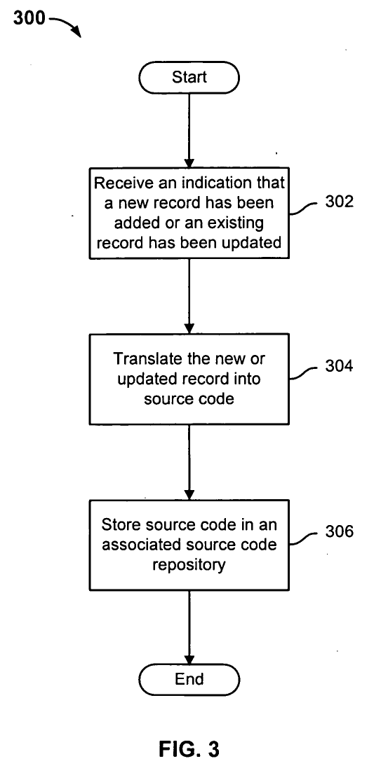

FIG. 3 illustrates an embodiment of a process for generating source code for function argument behavior of a function that is specified in an associated record in a database. For example, process 300 may be employed to generate source code 106 in FIG. 1. Process 300 starts at 302 at which an indication that a new record has been added to the database and/or an existing record has been updated is received. At 304, the new or updated record is translated by a translation script (e.g., translation script 104 of FIG. 1) into source code (e.g., source code 106 of FIG. 1). At 306, the source code generated at 304 is stored in an associated source code repository (e.g., source code repository 108 of FIG. 1), and process 300 subsequently ends. In the case of an updated function record, in some embodiments, the updated source code generated at 304 and stored at 306 replaces or overwrites corresponding existing source code associated with the function record in the source code repository.

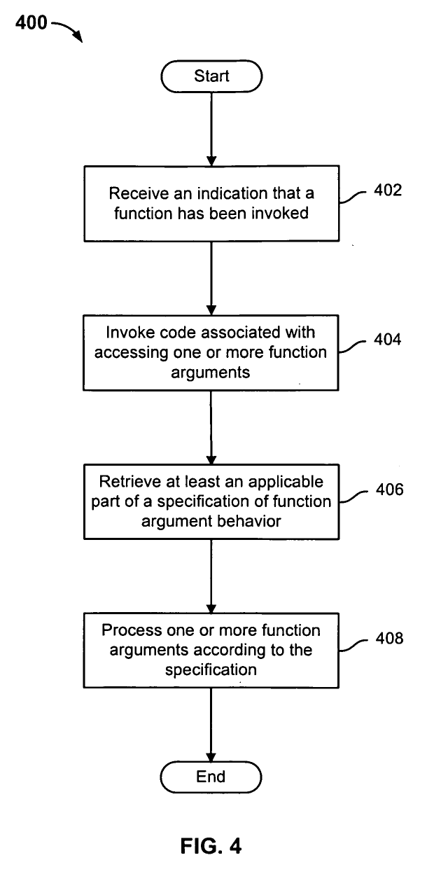

FIG. 4 illustrates an embodiment of a runtime process for retrieving code associated with function argument behavior. Process 400 starts at 402 at which an indication that a function has been invoked is received. At 404, code associated with accessing one or more arguments of the function is invoked. At 406, at least an applicable part of a specification of function argument behavior is retrieved, e.g., by the invoked code. For example, 406 may comprise retrieving an associated function record from a database (e.g., database 102 of FIG. 1) and/or associated translated and/or compiled code. At 408, one or more function arguments are processed according to the specification retrieved at 406, and process 400 subsequently ends. In various embodiments, 408 may include checking whether one or more arguments satisfy one or more specified properties, translating one or more arguments to prescribed types, ignoring one or more referenced cells, generating errors for one or more disallowed types of arguments, etc. In various embodiments, process 400 may be repeated for one or more arguments of the function that is invoked.

As described, in some embodiments, various properties associated with function arguments are parameterized, and the specification of such properties is abstracted from other parts of a function definition.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for defining spreadsheet function behavior, comprising:
receiving a selection of a parameterized spreadsheet function behavior to be associated with a spreadsheet function; and
associating the parameterized spreadsheet function behavior with the spreadsheet function based at least in part on the selection.

2. The method recited in claim 1, wherein the parameterized spreadsheet function behavior relates to how an operation of the spreadsheet function is performed with respect to a function argument based at least in part on a property of one or more data values associated with the argument.

3. The method recited in claim 1, wherein associating the parameterized spreadsheet function behavior with the spreadsheet function includes storing in a function definition database a record that associates the parameterized spreadsheet function behavior with the spreadsheet function.

4. The method recited in claim 3, further comprising using a translation script to translate data associated with the record to source code that implements the parameterized spreadsheet function behavior.

5. The method recited in claim 4, wherein the source code is stored in a source code repository.

6. The method recited in claim 1, wherein code associated with the parameterized spreadsheet function behavior is reused for a plurality of spreadsheet functions with respect to which the parameterized spreadsheet function behavior is selected.

7. The method recited in claim 6, further comprising receiving an indication of a change in the code associated with the parameterized spreadsheet function behavior and automatically updating associated source code for each of the plurality of spreadsheet functions.

8. The method recited in claim 1, wherein the selection is received via a user interface.

9. A system for defining spreadsheet function behavior, comprising:
a processor configured to:
receive a selection of a parameterized spreadsheet function behavior to be associated with a spreadsheet function; and
associate the parameterized spreadsheet function behavior with the spreadsheet function based at least in part on the selection; and
a memory coupled to the processor and configured to provide the processor with instructions.

10. The system recited in claim 9, wherein the parameterized spreadsheet function behavior relates to how an operation of the spreadsheet function is performed with respect to a function argument based at least in part on a property of one or more data values associated with the argument.

11. The system recited in claim 9, wherein to associate the parameterized spreadsheet function behavior with the spreadsheet function includes to store in a function definition database a record that associates the parameterized spreadsheet function behavior with the spreadsheet function.

12. The system recited in claim 11, wherein the processor is further configured to use a translation script to translate data associated with the record to source code that implements the parameterized spreadsheet function behavior.

13. The system recited in claim 9, wherein code associated with the parameterized spreadsheet function behavior is reused for a plurality of spreadsheet functions with respect to which the parameterized spreadsheet function behavior is selected.

14. The system recited in claim 13, wherein the processor is further configured to receive an indication of a change in the code associated with the parameterized spreadsheet function behavior and automatically update associated source code for each of the plurality of spreadsheet functions.

15. A computer program product for defining spreadsheet function behavior, the computer program product being embodied in a computer readable storage medium and comprising computer instructions for:
receiving a selection of a parameterized spreadsheet function behavior to be associated with a spreadsheet function; and
associating the parameterized spreadsheet function behavior with the spreadsheet function based at least in part on the selection.

16. The computer program product recited in claim 15, wherein the parameterized spreadsheet function behavior relates to how an operation of the spreadsheet function is performed with respect to a function argument based at least in part on a property of one or more data values associated with the argument.

17. The computer program product recited in claim 15, wherein associating the parameterized spreadsheet function behavior with the spreadsheet function includes storing in a function definition database a record that associates the parameterized spreadsheet function behavior with the spreadsheet function.

18. The computer program product recited in claim 17, further comprising computer instructions for using a translation script to translate data associated with the record to source code that implements the parameterized spreadsheet function behavior.

19. The computer program product recited in claim 15, wherein code associated with the parameterized spreadsheet function behavior is reused for a plurality of spreadsheet functions with respect to which the parameterized spreadsheet function behavior is selected.

20. The computer program product recited in claim 19, further comprising computer instructions for receiving an indication of a change in the code associated with the parameterized spreadsheet function behavior and automatically updating associated source code for each of the plurality of spreadsheet functions.
